(19) United States
(12) Patent Application Publication
(10) Pub. No.: US 2012/0113682 A1
(43) Pub. Date: May 10, 2012

(54) SURFACE LIGHTING APPARATUS

(75) Inventors: Takeshi Morino, Yokohama-shi (JP); Masataka SHIRATSUCHI, Kawasaki-shi (JP); Yoshinori HONGUH, Yokohama-shi (JP); Masahiro BABA, Yokohama-shi (JP); Ryosuke NONAKA, Yokohama-shi (JP); Masako KASHIWAGI, Yokohama-shi (JP); Yutaka NAKAI, Yokohama-shi (JP)

(73) Assignee: KABUSHIKI KAISHA TOSHIBA

(21) Appl. No.: 13/241,490

(22) Filed: Sep. 23, 2011

(30) Foreign Application Priority Data
Nov. 9, 2010 (JP) 2010-251130

(51) Int. Cl. F21V 8/00

(52) U.S. Cl. 362/613

(57) ABSTRACT

According to one embodiment, a surface lighting apparatus includes surface light source units stacked, and a control unit. Each surface light source unit includes a light guide plate and light-emitting units. The light guide plate includes a light incident surface for introducing light emitted by the light-emitting units, and a light-outputting region configured to output light through a front surface. The front surface is provided with a light transmission control part to prevent light from diffusing in a direction of arranging the light-emitting units. The light-emitting units are linearly arranged opposite to the light incident surface. The control unit controls a light intensity for each of the light-emitting units. A light guide plate of each surface light source unit other than a lowermost surface light source unit further includes a window region configured to transmit light output from one or more lower surface light source units.

### CROSS-REFERENCE TO RELATED APPLICATIONS

This application is based upon and claims the benefit of priority from prior Japanese Patent Application No. 2010-251130, filed Nov. 9, 2010, the entire contents of which are incorporated herein by reference.

### FIELD

Embodiments described herein relate generally to a surface lighting apparatus which can adjust luminance for each of partial regions on a light emission surface thereof.

### BACKGROUND

In recent years, using liquid crystal displays (LCDs) as large-size and thin-shaped television apparatuses and display devices has widely increased. LCDs themselves cannot emit light to perform display, and thus include a surface lighting apparatus (also referred to as a backlight device) corresponding to a light source apparatus.

Backlight devices are broadly classified into a direct type and an edge-light type. In the prior art, backlight devices of the direct type using a cold cathode fluorescent lamp (CCFL) have been used. In recent years, the power of light-emitting diodes (LEDs) has been increased and luminous efficiency of LEDs has been improved, and thus LEDs have become used as a light source for backlight devices.

When LEDs are used as a light source for backlight devices, a plurality of LEDs are connected as one block, the LEDs are independently controlled for each block, and thereby light control for each of partial regions (i.e., local dimming control) can be performed. In addition, luminance of the backlight device is controlled for each partial region in accordance with an image to be displayed, and thereby a contrast ratio between light and dark parts of the image can be increased, and power consumption can be reduced.

However, backlight devices of the direct type using LEDs require a number of LEDs, and thus have the problem of increase in cost. In addition, since LEDs are point light sources, it is necessary to dispose a light diffusion plate between the LEDs and the liquid crystal panel to obtain uniform luminance distribution. To achieve sufficient uniformity of luminance distribution, it is required to secure a certain amount of distance between the LEDs and the light diffusion plate, and thus direct type backlight devices using LEDs are not suitable for achieving reduction in thickness of the LCDs.

Backlight devices of the edge-light type using LEDs and light guide plates in combination can solve the above problems. However, backlight devices of the edge-light type have the problem that uneven luminance is easily generated. In addition, when a number of diffusion sheets are used to prevent uneven luminance, the problem of increase in cost and the problem of reduction in light use efficiency of LEDs are caused.

### BRIEF DESCRIPTION OF THE DRAWINGS

FIG. 1 is a perspective view schematically showing a surface lighting apparatus according to a first embodiment.

FIG. 2A is a plan view schematically showing an upper surface light source unit shown in FIG. 1.

FIG. 2B is a plan view schematically showing a lower surface light source unit shown in FIG. 1.

FIG. 3A is a diagram showing an example of light transmission control parts which are formed in light guide plates shown in FIG. 1.

FIG. 3B is a diagram showing another example of the light transmission control parts which are formed in light guide plates shown in FIG. 1.

FIG. 4 is a block diagram specifically showing line light sources shown in FIG. 1.

FIG. 5A is a diagram showing a light-emitting region which corresponds to a specific light-emitting unit in the upper surface light source unit shown in FIG. 1.

FIG. 5B is a diagram showing a light-emitting region which corresponds to a specific light-emitting unit in the lower surface light source unit shown in FIG. 1.

FIG. 6 is a schematic diagram showing partial regions, luminance of which can be controlled when the surface lighting apparatus of FIG. 1 is used as a backlight device of a liquid crystal display.

FIG. 7A is a schematic plan view of the upper light source unit according to a modification of the first embodiment.

FIG. 7B is a schematic plan view of the lower light source unit according to the modification of the first embodiment.

FIG. 8 is a graph which schematically illustrates luminance distributions of the upper and lower surface light source units shown in FIG. 7A and FIG. 7B, respectively.

FIG. 9A is a diagram illustrating a state where light from a line light source of each layer of FIG. 1 is directly made incident on a light guide plate of the different layer.

FIG. 9B is a diagram illustrating a state where light from a line light source of each layer of FIG. 1 is prevented by a light shielding member from being directly made incident on a light guide plate of the different layer.

FIG. 10 is a perspective view schematically showing a surface lighting apparatus according to a second embodiment.

FIG. 11A is a plan view schematically showing an upper light source unit shown in FIG. 10.

FIG. 11B is a plan view schematically showing a lower light source unit shown in FIG. 10.

FIG. 12 is a perspective view schematically showing a surface lighting apparatus according to a third embodiment.

FIG. 13A is a plan view schematically showing an upper light source unit shown in FIG. 12.

FIG. 13B is a plan view schematically showing a lower light source unit shown in FIG. 12.

FIG. 14 is a schematic diagram showing partial regions, luminance of which can be controlled when the surface lighting apparatus of FIG. 10 is used as a backlight device of a liquid crystal display.

FIG. 15 is a perspective view schematically showing a surface lighting apparatus according to a modification of the third embodiment.

FIG. 16A is a plan view schematically showing an upper light source unit shown in FIG. 15.

FIG. 16B is a plan view schematically showing a lower light source unit shown in FIG. 15.

### DETAILED DESCRIPTION

In general, according to one embodiment, a surface lighting apparatus includes a plurality of surface light source units stacked one on another, and a control unit. Each of the surface light source units includes a light guide plate and a plurality of light-emitting units. The light guide plate includes a light incident surface for introducing light emitted by the light-emitting units, a front surface, a back surface opposed to the front surface, and a light-outputting region configured to output light introduced from the light incident surface through the front surface. The front surface is provided with a light transmission control part to prevent light from diffusing in a direction of arranging the light-emitting units. The light-emitting units are linearly arranged opposite to the light incident surface and configured to emit light toward the light incident surface. The control unit is configured to control a light intensity for each of the light-emitting units. A light guide plate of each surface light source unit other than a lowermost surface light source unit of the surface light source units further includes a window region configured to transmit light which is output from one or more lower surface light source units and is introduced from a back surface thereof.

Hereinafter, surface lighting apparatuses according to various embodiments will be described with reference to the accompanying drawings. The surface lighting apparatus of each embodiment is the edge-light type and is used as, for example, a backlight device of a liquid crystal display. When the surface lighting apparatus is used as the backlight device of a liquid crystal display, the surface lighting apparatus is arranged such that a light emission surface thereof is opposed to a back surface of a liquid crystal panel.

In the following embodiments, like reference numbers denote like elements, and duplication of explanation will be avoided.

### First Embodiment

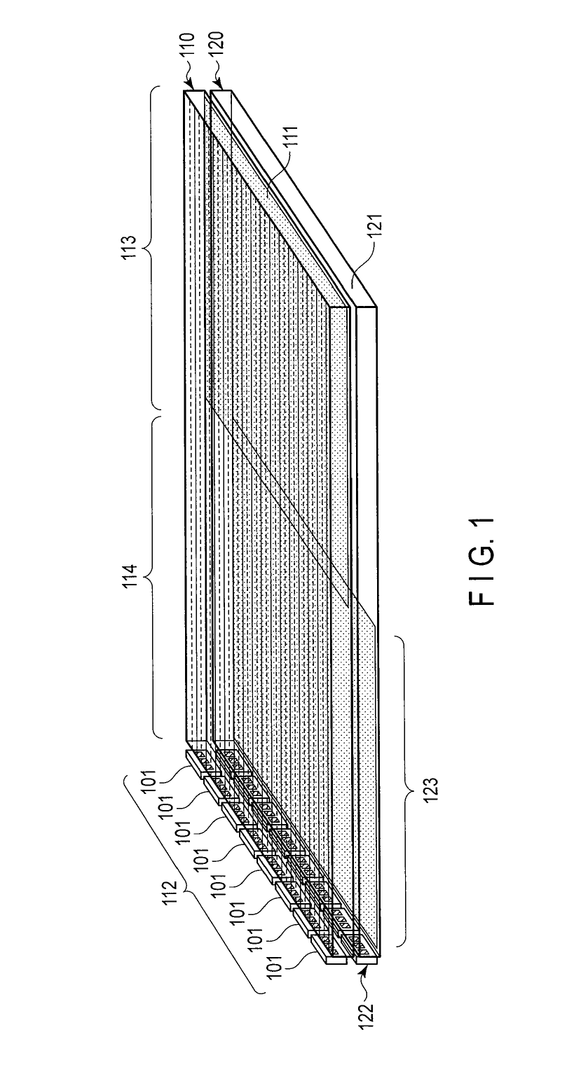

FIG. 1 schematically shows a surface lighting apparatus according to a first embodiment. As shown in FIG. 1, the surface lighting apparatus includes a plurality (two in FIG. 1) of surface light source units 110 and 120 which are stacked one on another. The surface light source units 110 and 120 include light guide plates 111 and 121 and line light sources 112 and 112, respectively. The light guide plates 111 and 121 and the line light sources 112 and 122 are fixed in a frame-shaped housing (not shown).

The light guide plates 111 and 121 are formed of a transparent material and formed in a thin plate shape. As the material of the light guide plates 111 and 121, it is possible to use, for example, resin material such as acrylic resin and polycarbonate resin.

Each of the light guide plates 111 and 112 has a front surface (also called a main surface), a back surface, and four side surfaces. The front surface and the back surface are opposed to each other in a stacking direction. The stacking direction is a direction in which surface light source units 110 and 120 are stacked or laid one on another, and corresponds to a thickness direction of the light guide plates 111 and 121. In FIG. 1, the front surface of the light guide plate 111 corresponds to the light emission surface of the surface lighting apparatus. The back surface of the light guide plate 111 is opposed to the front surface of the light guide plate 121. In the embodiments, a direction which goes from the light guide plate 121 toward the light guide plate 111 is defined as upper (upward) direction, and a direction which goes from the light guide plate 111 toward the light guide plate 121 is defined as lower (downward) direction. In this case, the upper direction corresponds to a direction in which the surface lighting apparatus of FIG. 1 emits light. In each of the light guide plates 111 and 121, the upper surface is defined as the front surface, and the lower surface is defined as the back surface.

The line light source 112 is arranged so as to be opposed to a side surface (also referred to as a light incident surface) selected from the side surfaces of the light guide plate 111, and emits light toward the light incident surface. The line light source 122 is arranged in parallel with the line light source 112 and so as to be opposed to a side surface (also referred to as a light incident surface) selected from the side surfaces of the light guide plate 121, and emits light toward the light incident surface. Each of the line light sources 112 and 122 includes a plurality (for example, eight) of light-emitting units 101, and these light-emitting units 101 are linearly arranged along the light incident surface of each of the light guide plates 111 and 121. In addition, each of the light-emitting unit 101 includes one or more light-emitting elements which generate light. In the case where each of the light-emitting units 101 includes a plurality of light-emitting elements, the light-emitting elements of each light-emitting unit 101 are linearly arranged along the direction of arranging the light-emitting units 101.

The light guide plate 111 includes a light-outputting region 113 which upward outputs light emitted by the line light source 112 and introduced from the light incident surface. Further, the light guide plate 111 includes a window region 114 which lets the light output from the surface light source unit 120 pass through and transmits the light. The light guide plate 121 includes a light-outputting region 123 which upward outputs light emitted by the line light source 122 and introduced from the light incident surface. The window region 114 of the light guide plate 111 and the light-outputting region 123 of the light guide plate 121 overlap each other in the stacking direction.

The light-outputting regions 113 and 123 are formed in the light guide plates 111 and 121, respectively, by arranging a number of diffusion marks which diffuse and reflect light. The diffusion marks may be minute concavities and convexities which are formed on the back surfaces of the light guide plates 111 and 121 in a three-dimensional manner. The diffusion marks may be white printing which is formed on the back surfaces of the light guide plates 111 and 121 by silk-screen printing or the like. The diffusion marks may be particles which have light-diffusion characteristic and added to each of the light guide plates 111 and 121.

The light-outputting region 113 guides light emitted by the line light source 112 such that the light is radiated upward from the front surface of the light guide plate 111. On the other hand, light emitted by the line light source 122 is made incident on the light incident surface of the light guide plate 121, reflected and diffused by reflection marks in the light-outputting region 123, and output upward from the light-outputting region 123. The light output from the light-outputting region 123 is transmitted through the window region 114 of the light guide plate 111, and output upward from the front surface of the light guide plate 111.

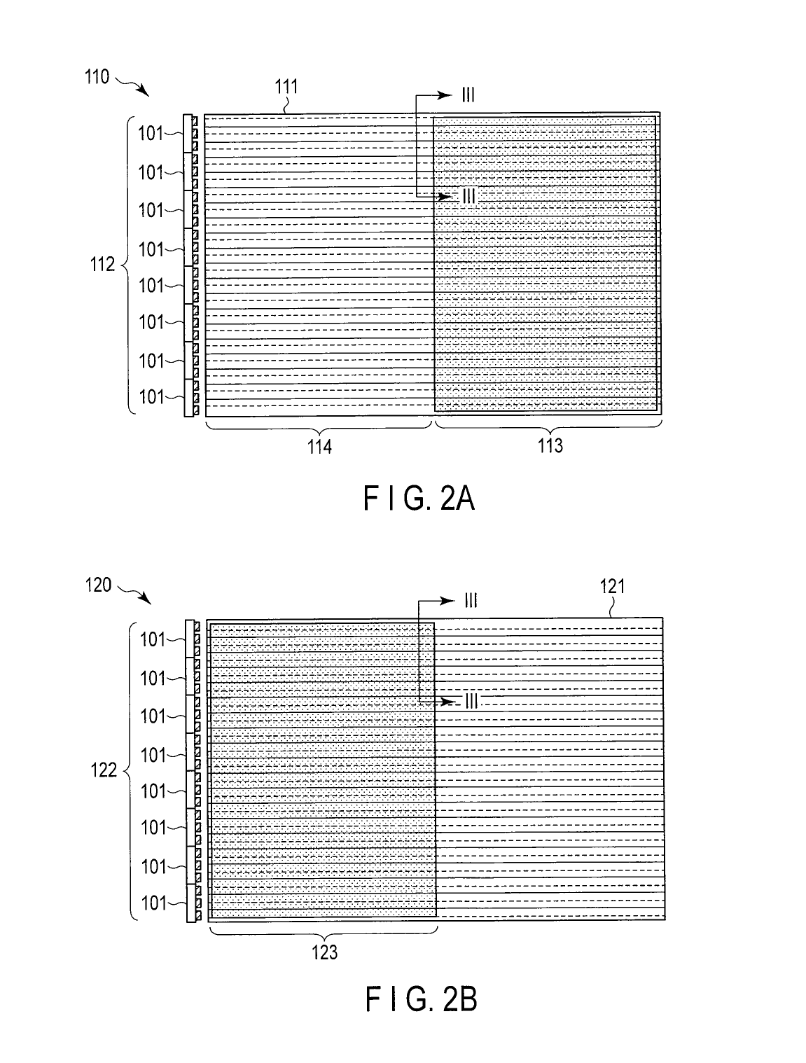

FIG. 2A and FIG. 2B show the surface light source units 110 and 120, respectively, separately from each other, and are plan views of the surface light source units 110 and 120, respectively, as viewed from above. As shown in FIG. 2A, about half a region of the light guide plate 111 of the surface light source unit 110, which includes a side on which the line light source 112 is arranged, is the window region 114, and the rest region is the light-outputting region 113. In addition, as shown in FIG. 2B, about half a region of the light guide plate 121 of the surface light source unit 120, which includes a side on which the line light source 122 is arranged, is the light-outputting region 123.

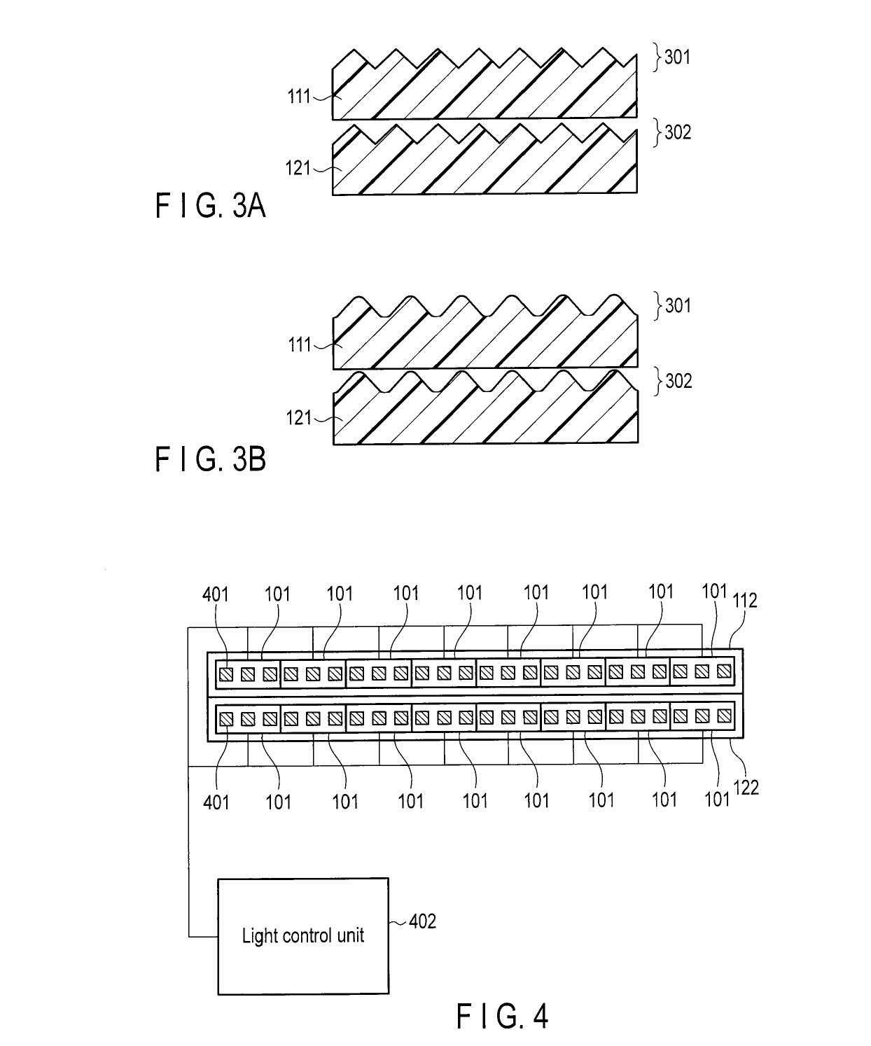

FIG. 3A shows an example of a cross-sectional shape of the light guide plates 111 and 121, taken along lines illustrated in FIG. 2A and FIG. 2B. As shown in FIG. 3A, light transmission control parts 301 and 302 are provided on the front surfaces of the light guide plates 111 and 121, respectively. Each of the light transmission control parts 301 and 302 has a prism structure in which a plurality of linear prisms are arranged in parallel. FIG. 3A shows an example in which a cross section of each linear prism has an isosceles triangle shape.

The linear prisms which are provided in each of the light guide plates 111 and 121 are formed along a direction (light-emitting direction) in which each of the line light sources 112 and 122 emits light. The light-emitting direction of the line light sources 112 and 122 is a direction which is substantially perpendicular to the stacking direction and the direction of arranging the light-emitting units 101. That is, the light-emitting direction is substantially perpendicular to the light incident surface which each of the line light source 112 and 122 faces. Thus, each of the light transmission control parts 301 and 302 has depressed parts and projecting parts which are linearly extended in the light-emitting direction.

A cross-sectional component of the light along line which is transmitted through the light guide plate 111, is subjected to retroreflection by the prism structure. The light which is emitted by the line light source 112 and made incident on the light incident surface of the light guide plate 111 is transmitted while being subjected to retroreflection in the light guide plate 111, thus widely diffused in the light-emitting direction of the line light source 112, and is hardly diffused in the direction of arranging the light-emitting units 101.

In the same manner, a cross-sectional component of the light along line which is transmitted through the light guide plate 121, is subjected to retroreflection by the prism structure. The light which is emitted from the line light source 122 and made incident on the light incident surface of the light guide plate 121 is transmitted while being subjected to retroreflection in the light guide plate 121, thus widely diffused in the light-emitting direction of the line light source 122, and is hardly diffused in the direction of arranging the light-emitting units 101.

The light transmission control parts 301 and 302 are not limited to the example which includes linear prisms that have an isosceles triangle cross section as shown in FIG. 3A. The light transmission control parts 301 and 302 may have a structure in which a plurality of linear prisms that have a hemispheric or trapezoidal cross section are arranged, as long as retroreflection can be obtained to suppress diffusion of light in the direction of arranging the light-emitting units 101. In addition, the linear prisms may have different sizes, or different linear prisms which have triangular, hemispherical, and trapezoidal cross sections may be used in combination. Besides, in consideration of manufacturability, the light transmission control parts 301 and 302 may have a structure in which linear prisms which have a triangular cross section with rounded vertices are arranged in parallel, as shown in FIG. 3B.

FIG. 4 more specifically shows the line light sources 122 and 122. As shown in FIG. 4, each of the line light sources 112 and 122 includes a plurality of light-emitting units 101 which are arranged in line along a light incident surface which each of the line light sources 112 and 122 faces. Each of the light-emitting units 101 includes a plurality of light-emitting elements 401 which are arranged in line along the light incident surface which each of the line light sources 112 and 122 faces, that is, along the direction of arranging the light-emitting units 101. As the light-emitting elements 401, it is possible to use, for example, white light emitting diodes (LEDs) which emit white light.

Each of the light-emitting elements 401 may be an LED module which generates white light by using LEDs of different colors in combination. For example, the LED module which generates white light includes a red LED, a green LED, and a blue LED.

The light-emitting units 101 are electrically connected to a light control unit 402. The light control unit 402 can turn on/off and control light intensity of the respective light-emitting units 101 independently. For example, the light control unit 402 supplies direct current to each light-emitting unit 101, and controls the light intensity of each light-emitting unit 101 by changing the value of the direct current. As another example, the light control unit 402 supplies high-frequency pulse current to each light-emitting unit 101 to blink on and off the light-emitting unit 101 at high speed, and controls the light intensity of each light-emitting unit 101 by changing a duty ratio of the pulse current.

The number of the light-emitting units 101 which are provided in each of the line light sources 112 and 122 is not limited to eight as shown in FIG. 4, but may be 7 or less, or 9 or more. In addition, each light-emitting unit 101 is not limited to the example of including three light-emitting elements 401 as shown in FIG. 4, but may have one light-emitting element 401, or two or four or more light-emitting elements 401.

As described above, in the surface light source unit 110, the light guide plate 111 includes the light transmission control part 301, and the line light source 112 includes the plurality of light-emitting units 101. By using the light guide plate 111 and the line light source 112 in combination, a region in which light emitted by each light-emitting unit 101 is output is an elongated rectangular region in the light-outputting region 113, which runs along a linear direction of the prism structure, i.e., the light-emitting direction of the line light source 112. In addition, in the surface light source unit 120, the light guide plate 121 including the light transmission control part 302 and the line light source 122 including the light-emitting units 101. By using the light guide plate 121 and the line light source 122 in combination, a region in which light emitted by each light-emitting unit 101 is output is an elongated region in the light-outputting region 123, which runs along a linear direction of the prism structure, i.e., the light-emitting direction of the line light source 122.

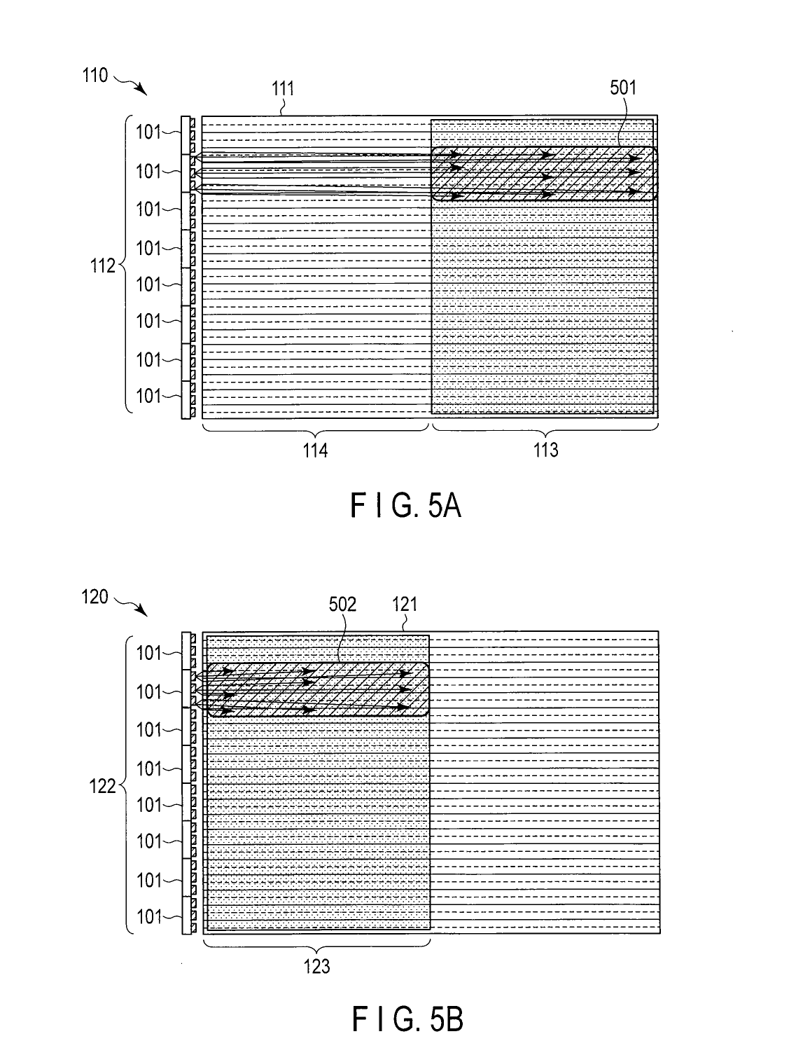

FIG. 5A schematically shows a partial region 501 from which light is output when one light-emitting unit 101 in the line light source 112 emits light. As shown in FIG. 5A, when one light-emitting unit 101 in the line light source 112 is caused to emit light, the light emitted by the light-emitting unit 101 is transmitted while repeating total reflection inside the window region 114 of the light guide plate 111, and reaches the light-outputting region 113. In the light-outputting region 113, a part of the reached light is diffusely reflected by the diffusion marks on the back surface of the light guide plate 111 and output upward from the front surface of the light guide plate 111, and the other part is transmitted in a direction of further going away from the light-emitting unit 101.

In this transmission, in both the window region 114 and the light-outputting region 113, the light is guided in the light-emitting direction of the line light source 112 by the light transmission control part 301 provided on the front surface of the light guide plate 111, without diffusing in the direction of arranging the light-emitting units 101 of the line light source 112. Thereby, the region from which the light emitted by the light-emitting unit 101 is output can be restricted to the partial region 501 in the light-outputting region 113, which is shaded in FIG. 5A. Therefore, in the surface light source unit 110, it is possible to control luminance in each of partial regions in the light-outputting region 113 corresponding to the respective light-emitting units 101, by controlling light intensity of each light-emitting unit 101 in the line light source 112.

FIG. 5B schematically shows a partial region 502 from which light is output when one light-emitting unit 101 in the line light source 122 emits light. As shown in FIG. 5B, when one light-emitting unit 101 in the line light source 122 is caused to emit light, part of the light from the light-emitting unit 101 is diffusely reflected by the diffusion marks on the back surface of the light guide plate 111 in the light-outputting region 123 and output from the front surface of the light guide plate 121, and the other part is transmitted in a direction of further going away from the light-emitting unit 101.

In this transmission, in the light-outputting region 123, the light is guided in the light-emitting direction of the line light source 122 by the light transmission control part 302 provided on the front surface of the light guide plate 121, without diffusing in the direction of arranging the light-emitting units 101 of the line light source 122. Thereby, the region into which the light from the light-emitting unit 101 is output can be restricted to the partial region 502 in the light-outputting region 123, which is shaded in FIG. 5B. Therefore, in the surface light source unit 120, it is possible to control luminance in each of partial regions in the light-outputting region 123 corresponding to the respective light-emitting units 101, by controlling light intensity of each light-emitting unit 101 in the line light source 122.

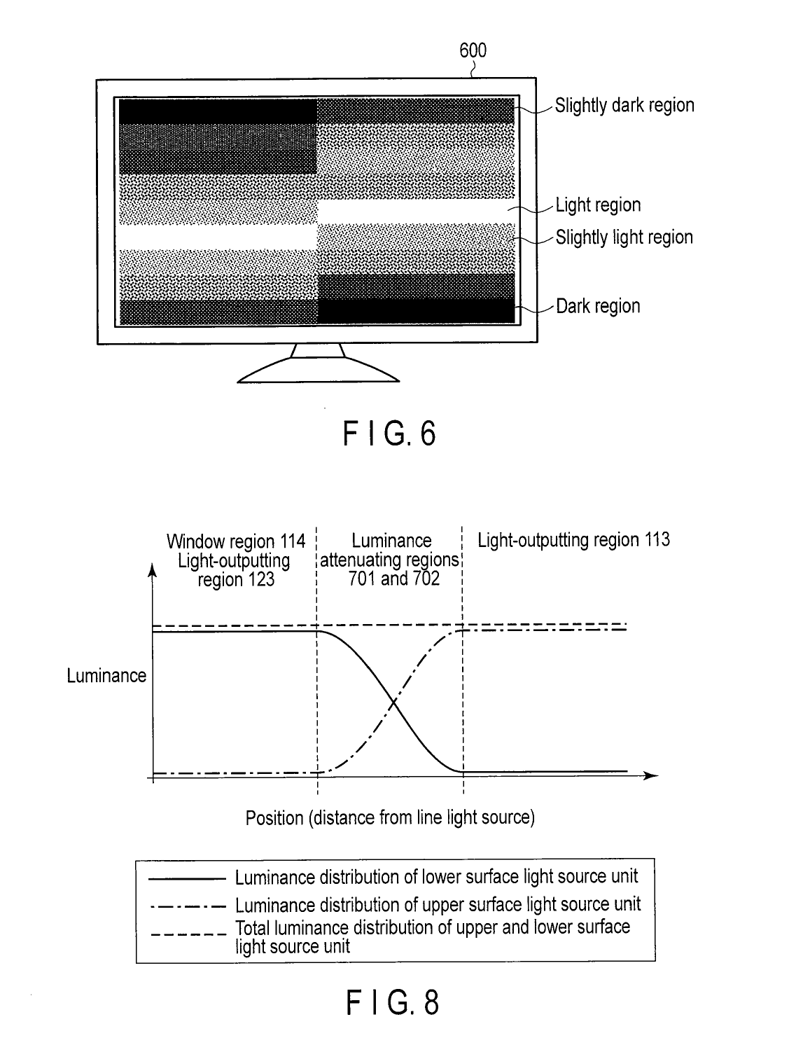

By stacking these surface light source units 110 and 120, the surface lighting apparatus of FIG. 1 can control luminance for each of partial regions into which the light emission surface is virtually divided. The number of partial regions, luminance of which can be controlled, depends on the number of the stacked surface light source units, and the number of light-emitting units included in each line light source. For example, in the surface lighting apparatus in which two surface light source units are stacked and each surface light source unit is provided with eight light-emitting units, it is possible to control luminance of each of partial regions which are obtained by dividing the light emission surface into 16. As shown in FIG. 6, when such a surface lighting apparatus is used as a backlight device of a liquid crystal display apparatus 600, it is possible to control luminance for each of partial regions which are obtained by dividing a display screen thereof into two in a horizontal direction and into eight in a vertical direction.

As described above, according to the surface lighting apparatus according to the present embodiment, it is possible to perform light control (local dimming control) for each of a plurality of partial regions, and easily secure uniform luminance. When the surface lighting apparatus of the present embodiment is applied to the backlight device of a liquid crystal display, it is possible to increase a contrast ratio between the light and dark parts of an image to be displayed and improve the image quality, by local dimming control. In addition, the surface lighting apparatus can perform control such as lightening only a necessary part according to the displayed image, therefore reducing the power consumption.

Although the present embodiment shows an example in which the two surface light source units 110 and 120 are stacked, three or more surface light source units may be stacked. In the case where three or more surface light source units are stacked, the window region is more shortened in the light-emitting direction of the line light source, i.e., in a direction perpendicular to the light incident surface. Further, in the surface light source unit of the lower side, the light-outputting region in the surface light source unit is shifted toward the light incident surface.

The case where the surface lighting apparatus has a structure in which three surface light source units are stacked will be explained hereinafter as an example. In the light guide plate of the lowermost surface light source unit, a region of ⅓ of the light guide plate, which is close to the light incident surface, is set as the light-outputting region. In the light guide plate of an intermediate surface light source unit, a region of about ⅓ of the light guide plate, which is close to the light incident surface, is set as the window region, and an about ⅓ region in the center part is set as the light-outputting region. In addition, in the light guide plate of the uppermost surface light source unit, a region of about ⅔ of the light guide plate, which is close to the light incident surface, is set as the window region, and the other region is set as the light-outputting region.

As described above, increasing the number of stacked surface light source units can increase the number of partial regions which can be light-controlled.

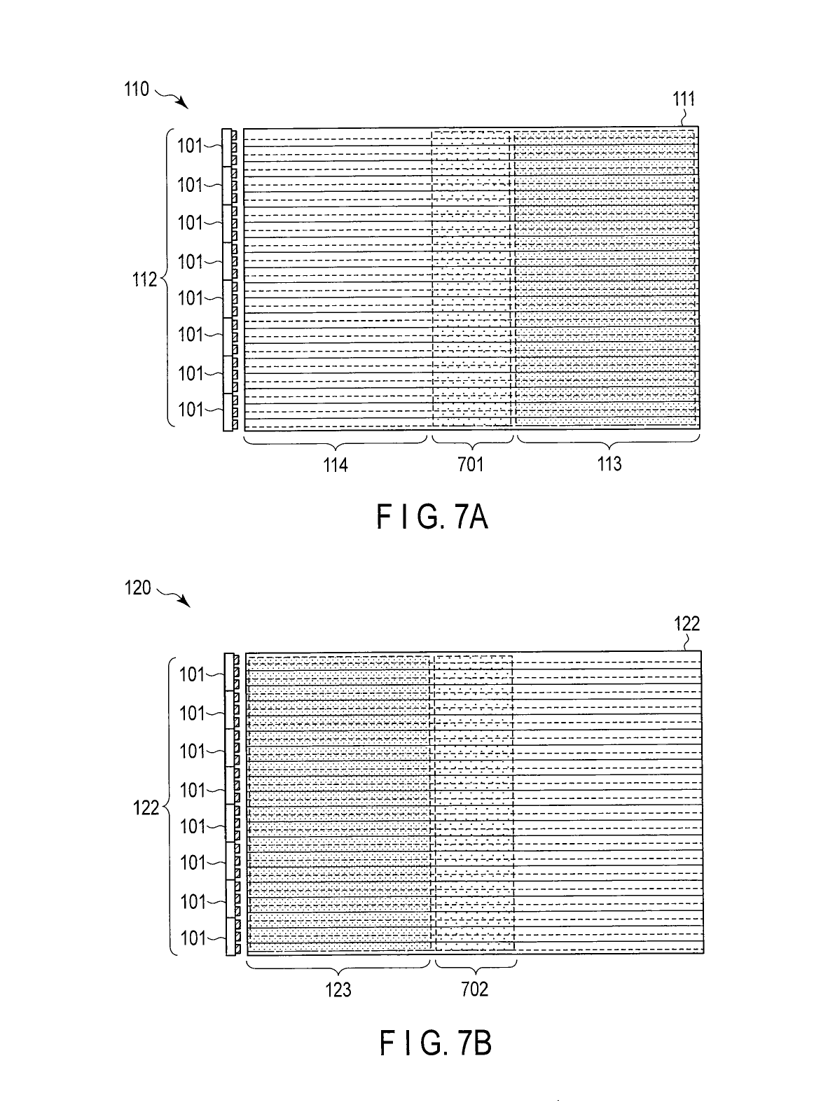

Next, a surface lighting apparatus according to a modification of the first embodiment will be explained hereinafter with reference to FIG. 7A, FIG. 7B, and FIG. 8.

In the surface lighting apparatus which can perform local dimming control as described above, there are cases where uniformity of luminance distribution is important when the whole screen is fully lit. To secure uniformity of luminance distribution in full lighting, the surface lighting apparatus according to the modification of the first embodiment is provided with a luminance attenuating region 701 between the light-outputting region 113 and the window region 114 of the light guide plate 111, and the light guide plate 121 is provided with a luminance attenuating region 702 to be superposed on the luminance attenuating region 701, as shown in FIG. 7A and FIG. 7B.

Diffusion marks are distributed in the luminance attenuating region 701 of the light guide plate 111, such that luminance gradually increases from the end of the window region 114 toward the end of the light-outputting region 113. Specifically, in the luminance attenuating region 701 of the light guide plate 111, diffusion marks are provided such that distribution density increases in a direction of going away from the line light source 112.

In addition, diffusion marks are distributed in the luminance attenuating region 702 of the light guide plate 121, such that luminance gradually decreases from the end of the light-outputting region 123. Specifically, in the luminance attenuating region 702 of the light guide plate 121, the diffusion marks are provided such that luminance distribution decreases in a direction of going away from the line light source 122.

The diffusion marks of the luminance attenuating regions 701 and 702 may have a minute concavities and convexities which are formed on the back surfaces of the light guide plates 111 and 121 in a three-dimensional manner. Alternatively, the diffusion marks may be white printing which are formed on the back surfaces of the light guide plates 111 and 121 by silk-screen printing or the like.

Further, in order to enhance the effect of an increase and attenuation in luminance, light-absorption marks such as small black printing may be distributed in the luminance attenuating regions 701 and 702 in addition to the diffusion marks. Alternatively, black printing with a specific size may be applied to the luminance attenuating regions 701 and 702.

FIG. 8 shows an example of luminance distribution in the light emission surface of the surface lighting apparatus according to the modification of the first embodiment. In FIG. 8, the transverse axis indicates the distance from the line light source, and the vertical axis indicates luminance. In addition, in FIG. 8, luminance distribution of light emitted from the upper surface light source unit 110 is indicated by an alternate long and short dash line, and luminance distribution of light emitted from the lower surface light source unit 120 is indicated by a solid line. Luminance distribution of light emitted from the surface lighting apparatus, which is a total of the both luminance distributions, is indicated by a broken line.

As shown in FIG. 8, the luminance of the surface light source unit 120 is almost fixed in the light-outputting region 123, almost linearly attenuated in the luminance attenuating region 702 as the light goes away from the line light source 122, and reaches almost zero. In contrast, the luminance of the surface light source unit 110 is almost zero in the window region 114, almost linearly increases in the luminance attenuating region 701 as the light goes away from the line light source 112, and is almost fixed in the light-outputting region 113.

As described above, the surface light source units 110 and 120 are provided with the luminance attenuating regions 701 and 702, respectively, and thereby the luminance uniformity of the whole surface lighting apparatus can be secured when both the surface light source units are lit with the same luminance. In addition, it is possible to increase a margin for manufacturing error of the surface lighting apparatus, such as displacement of the light guide plates 111 and 121.

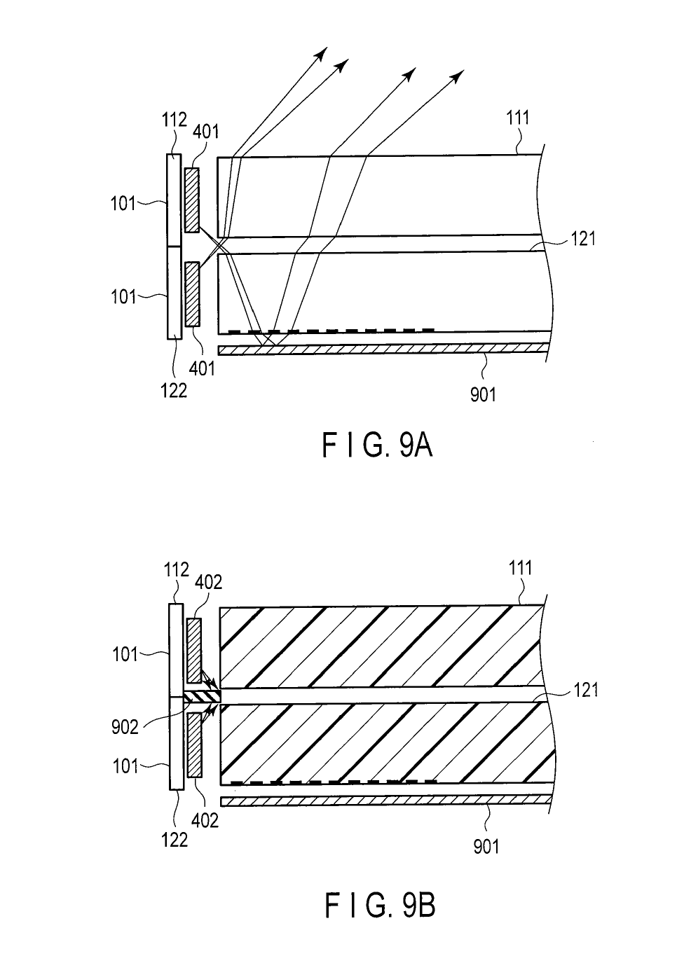

In the surface lighting apparatus according to the above embodiment and the modification thereof, there are cases where the light emitted from the lower line light source 122 is made incident on the back surface of the upper light guide plate 111, and directly output from the window region 114, as shown in FIG. 9A, according to the thickness of the light guide plates 111 and 121 and the relative sizes of the light-emitting parts of the line light sources 112 and 122. Further, in surface lighting apparatuses used for backlight devices, a reflection sheet 901 may be provided below a back surface of the lowermost light guide plate 121. In this case, the light emitted from the line light source 112 is made incident on the front surface of the light guide plate 121, transmitted through the light guide plate 121, reflected by the reflection sheet 901, and output through the light-outputting region 123 of the light guide plate 121 and the window region 114 of the light guide plate 111.

When there is such a leaking light which is generated by a cause other than diffusion of the diffusion marks of the light-outputting regions 113 and 123, luminance around the line light sources 112 and 112 increases, and unevenness in luminance distribution is generated. To prevent generation of such unevenness in luminance distribution, a light shielding member 902 which blocks light may be provided between the line light source 112 and the line light source 122. Preventing generation of leaking light as described above by the light shielding member 902 enables suppression of generation of unevenness in luminance distribution.

### Second Embodiment

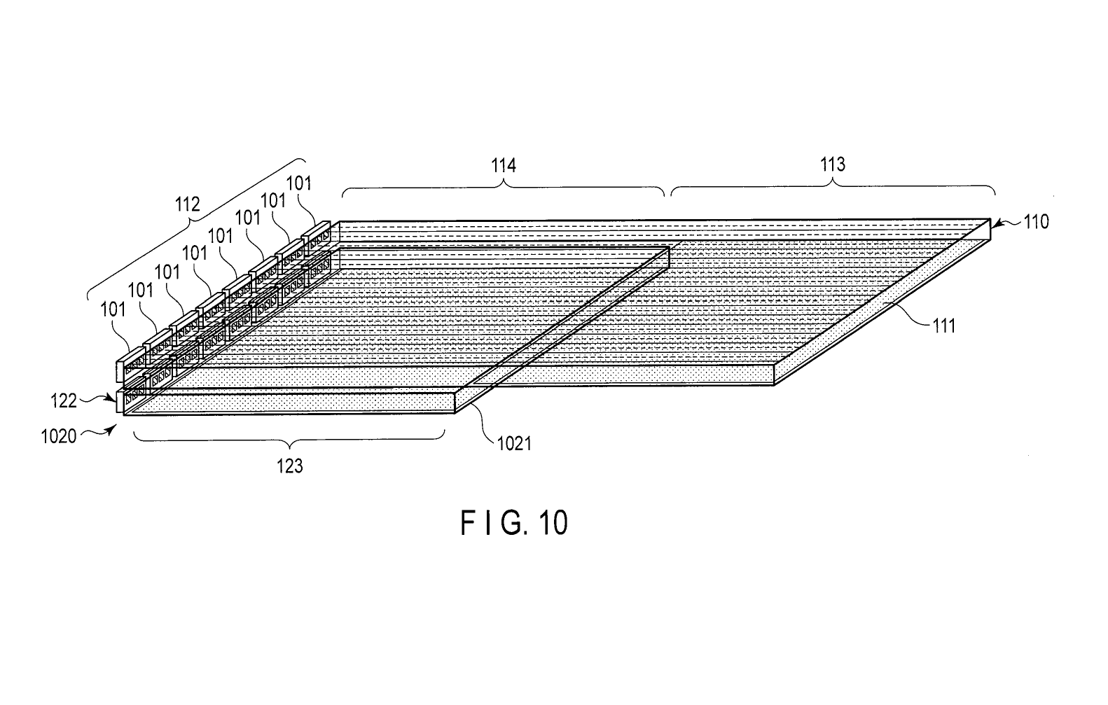

FIG. 10 schematically shows a surface lighting apparatus according to a second embodiment. The surface lighting apparatus has the structure in which a surface light source unit 110 and a surface light source unit 1020 are stacked one on another. The surface light source unit 110 includes a light guide plate 111 and a line light source 112 which arranged so as to be opposed to a side surface (light incident surface) of the light guide plate 111. The surface light source unit 1020 includes a light guide plate 1021 and a line light source 122 arranged so as to be opposed to a side surface (light incident surface) of the light guide plate 1021. The surface lighting apparatus of FIG. 10 is different from the surface lighting apparatus of FIG. 1, in the shape of the light guide plate of the lower surface light source unit.

Although the upper light guide plate 111 and the lower light guide plate 121 have the same size in the first embodiment, the lower light guide plate 1021 of the second embodiment is shorter than the upper light guide plate 111 in a light-emitting direction of the line light source 122. Specifically, the light guide plate 1021 is provided by removing a part other than the light-outputting region 123 from the light guide plate 121 of FIG. 1. Thereby, a stacked structure formed of the light guide plates 111 and 1021 has a stepped shape.

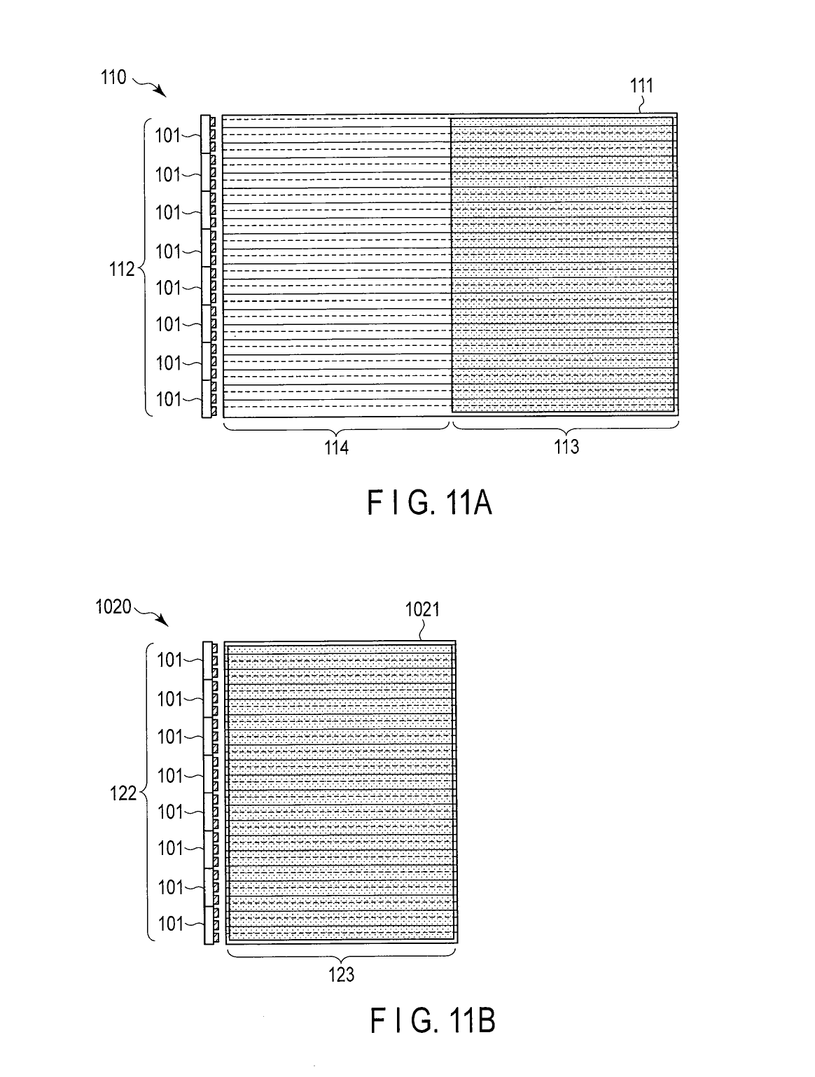

FIG. 11A and FIG. 11B show the surface light source units 110 and 1020 of FIG. 10, respectively, separately from each other, and are plan views of the surface light source units 110 and 1020 as viewed from above. In the light guide plate 111 of the surface light source unit 110 shown in FIG. 11A, about half a region of the light guide plate 111 on a side, on which the line light source 112 is arranged, is a window region 114, and the other region thereof is a light-outputting region 113.

As shown in FIG. 11B, almost the whole region of the light guide plate 1021 of the surface light source unit 1020 is a light-outputting region 123. The light guide plate 1021 is obtained by removing a part other than the light-outputting region 123 of the light guide plate 121 shown in FIG. 2B. A front surface of the light guide plate 1021 is provided with a light transmission control part 302, and a whole back surface of the light guide plate 1021 is provided with reflection marks.

Also in the present embodiment, each of the light guide plates 111 and 1021 may be provided with a luminance attenuating region, as shown in the modification of the first embodiment. In addition, as shown in FIG. 9, a light shielding member 902 may be provided between the surface light source unit 110 and the surface light source unit 1020.

As described above, the surface lighting apparatus according to the second embodiment can perform local dimming control and easily secure uniform luminance, like the first embodiment. In addition, the light guide plate of the lower surface light source unit is shortened in the light-emitting direction of the line light source, and thereby weight saving and material saving can be achieved.

### Third Embodiment

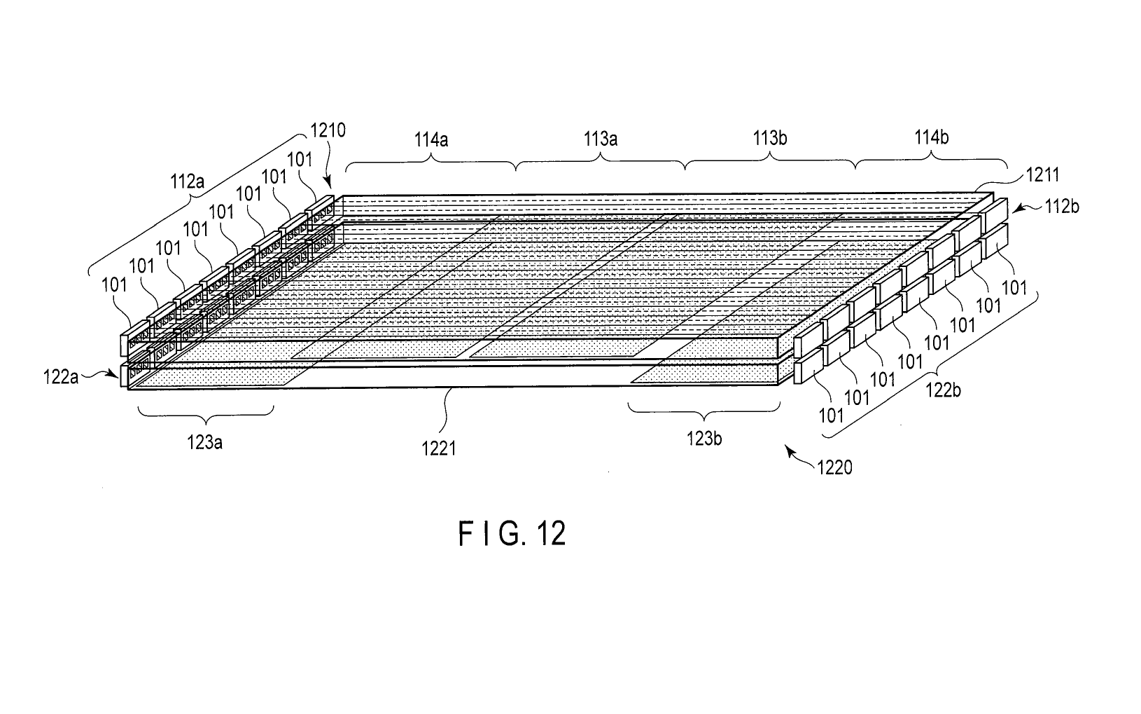

FIG. 12 schematically shows a surface lighting apparatus according to a third embodiment. The third embodiment has a structure in which the surface lighting apparatuses according to the first embodiment as shown in FIG. 1 are arranged in a lateral symmetrical manner, and the left and right light guide plates are united. The lateral direction indicates a light-emitting direction of a line light source.

The surface lighting apparatus of FIG. 12 includes a surface light source unit 1210 and a surface light source unit 1220 which are stacked. The surface light source unit 1210 includes a light guide plate 1211 and line light sources 112a and 112b arranged so as to be opposed to a pair of opposed side surfaces (light incident surfaces) of the light guide plate 1211. The surface light source unit 1220 includes a light guide plate 1221 and line light sources 122b and 122a arranged so as to be opposed to a pair of opposed side surfaces (light incident surfaces) of the light guide plate 1221.

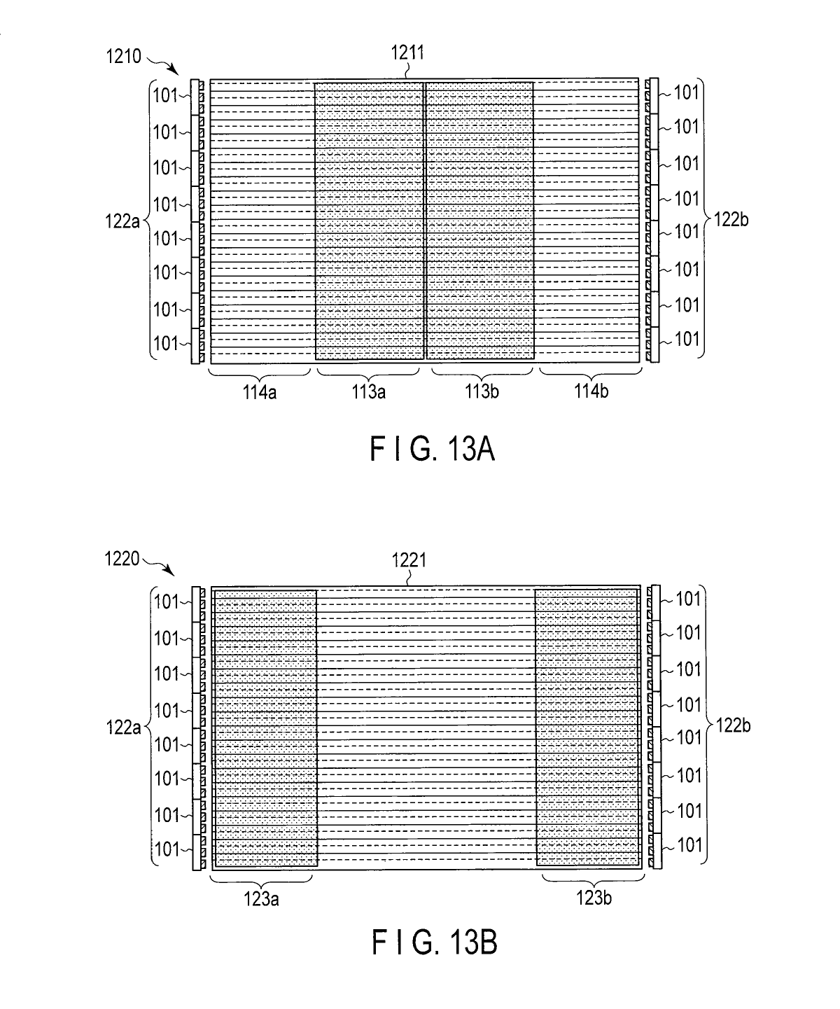

FIG. 13A and FIG. 13B show the surface light source units 1210 and 1220, respectively, separately from each other, and are plan views of the surface light source units 1210 and 1220 as viewed from above. As shown in FIG. 13A, in the surface light source unit 1210, light-outputting regions 113a and 113b are provided in a center part of the light guide plate 1211. Further, a window region 114a is provided in a region of ¼ of the light guide plate 1211, which is located on a side close to the light incident surface opposed to the line light source 112a, and a window region 114b is provided in a region of ¼ of the light guide plate 1211, which is located on a side close to the light incident surface opposed to the line light source 112b. The light-outputting region 113a guides light, which emitted by the line light source 112a and introduced from the light incident surface, such that the light is radiated upward from the front surface of the light guide plate 1211. The light-outputting region 113b guides light, which emitted by the line light source 112a and introduced from the light incident surface, such that the light is radiated upward from the front surface of the light guide plate 1211.

As shown in FIG. 13B, in the surface light source unit 1220, a light-outputting region 123a is provided in a region of ¼ of the light guide plate 1221, which is located on a side close to the light incident surface opposed to the line light source 122a. Further, a light-outputting region 123b is provided in a region of ¼ of the light guide plate 1221 of the surface light source unit 1220, which is located on a side close to the light incident surface opposed to the line light source 122b.

The window region 114a of the light guide plate 1211 and the light-outputting region 123a of the light guide plate 1221 overlap each other in the stacking direction. In addition; the window region 114b of the light guide plate 1211 and the light-outputting region 123b of the light guide plate 1221 overlap each other in the stacking direction.

Light emitted from the line light source 122a is made incident on the light incident surface of the light guide plate 1221, reflected and diffused by reflection marks in the light-outputting region 123a, and output upward from the light-outputting region 123a. The light output from the light-outputting region 123a is transmitted through the window region 114a of the light guide plate 1211, and output upward from the front surface of the light guide plate 1211.

In addition, light emitted from the line light source 122b is made incident on the light incident surface of the light guide plate 1221, reflected and diffused by reflection marks in the light-outputting region 123b, and output upward from the light-outputting region 123b. The light output from the light-outputting region 123b is transmitted through the window region 114b of the light guide plate 1211, and output upward from the front surface of the light guide plate 1211.

In addition, the front surfaces of the light guide plates 1211 and 1221 are provided with light transmission control parts 301 and 302 as shown in FIG. 3A, respectively, to suppress diffusion of light in the direction of arranging light-emitting units 101 in the light guide plates 1211 and 1221.

The light-outputting regions 113a and 113b and the window regions 114a and 114b of the light guide plate 1211 have the same respective functions as those of the light-outputting region 113 and the window region 114 of the light guide plate 111 of FIG. 1, the light-outputting regions 123a and 123b of the light guide plate 1221 have the same function as that of the light-outputting region 123 of the light guide plate 121 of FIG. 1, and thus detailed description thereof is omitted. In addition, the line light sources 112a, 112b, 122a, and 122b are the same as the line light sources 112 and 122 of FIG. 1, and explanation thereof is omitted.

Also in the present embodiment, each of the light guide plates 1211 and 1221 may be provided with a luminance attenuating region, as shown in the modification of the first embodiment. Besides, as shown in FIG. 9, a light shielding member may be provided between the line light source 112a and the line light source 122a, and between the line light source 112b and the line light source 122b. In addition, three or more surface light source units may be stacked.

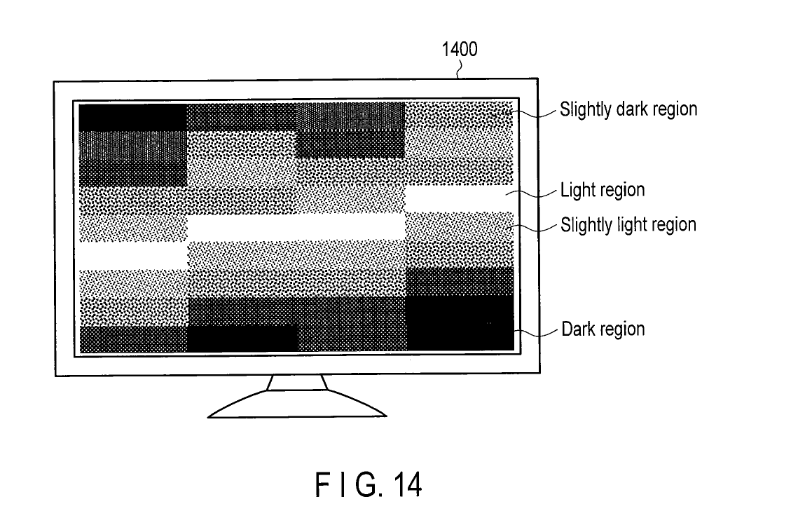

By stacking these surface light source units 1210 and 1220, the surface lighting apparatus of FIG. 12 can perform local dimming control. Since each surface light source unit is provided with eight light-emitting units 101 in the surface lighting apparatus of the present embodiment, luminance can be controlled for each of 32 partial regions. As shown in FIG. 14, when such a surface lighting apparatus is used as a backlight device of a liquid crystal display 1400, luminance can be controlled for each of partial regions which are obtained by dividing a display screen into four in the horizontal direction and dividing the screen into eight in the vertical direction.

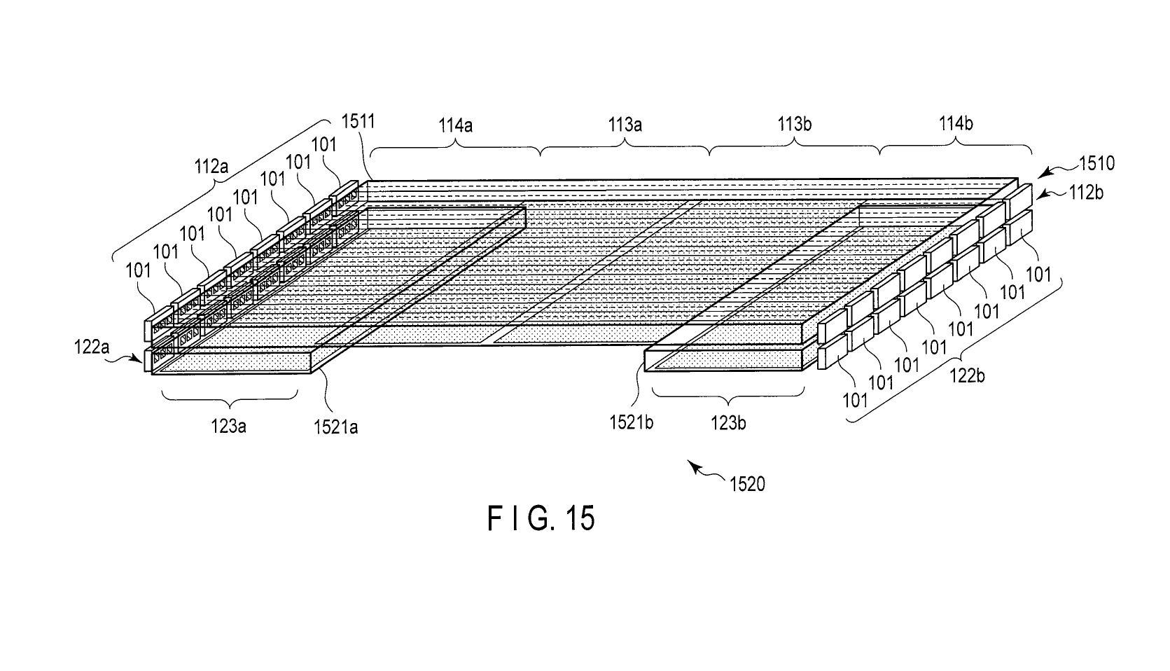

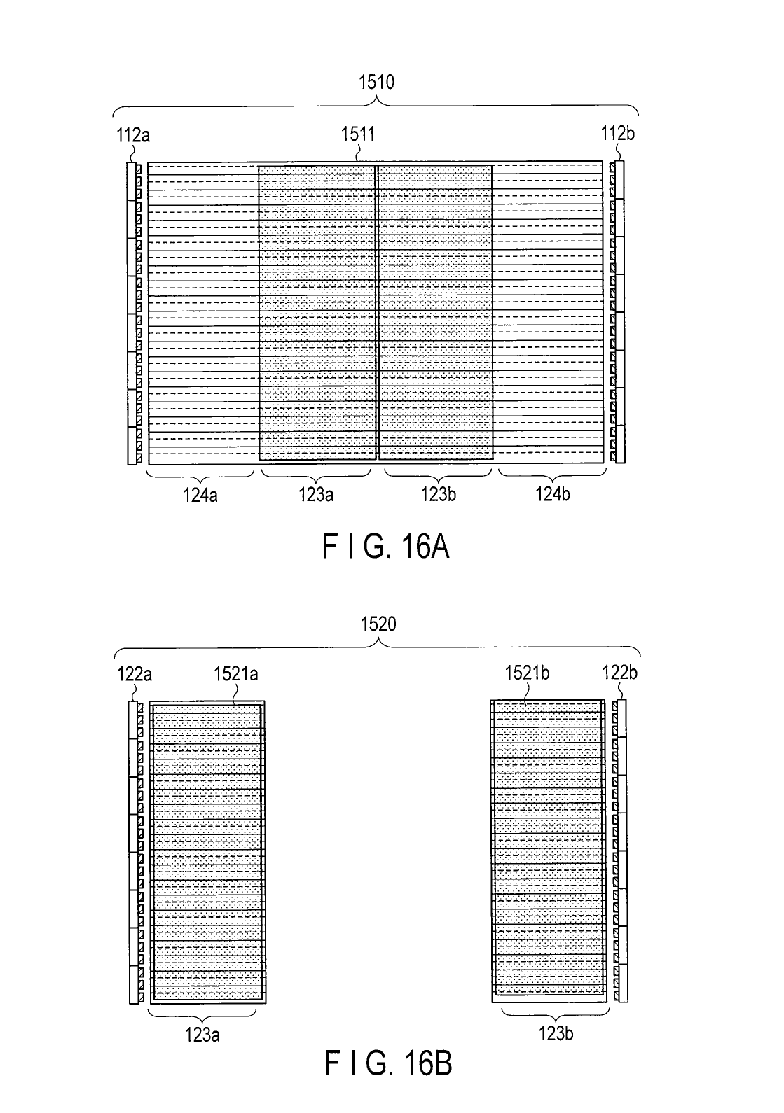

Although the present embodiment shows the example in which the surface lighting apparatuses of FIG. 1 are arranged in a lateral symmetrical manner, the surface lighting apparatuses as shown in FIG. 10 may be arranged in a lateral symmetrical manner, as shown in FIG. 15, FIG. 16A and FIG. 16B. In this case, an upper surface light source unit 1510 has the same structure as that of the surface light source unit 1210 of FIG. 12, that is, the upper surface light source unit 1510 includes the light guide plate 1511, and line light sources 112a and 112b arranged so as to be opposed to a pair of opposed side surfaces (light incident surfaces) of the light guide plate 1511. A lower surface light source unit 1520 includes two light guide plates 1521a and 1521b. The light guide plates 1521a and 1521b corresponds to a structure which is obtained by removing the center part of the light guide plate 1221 of FIG. 12 and separating the light-outputting regions 123a and 123b from each other.

Also when the surface lighting apparatus of FIG. 15 is used as a backlight device of a liquid crystal display, luminance can be controlled for each of partial regions which are obtained by dividing the display screen into four in the horizontal direction and into eight in the vertical direction, as shown in FIG. 14. In addition, when two or more surface light source units are stacked, light guide plates of layers other than the uppermost layer are shortened, and thus reduction in weight and material saving can be achieved.

According to at least one of the above embodiments, it is possible to provide a surface lighting apparatus which can perform light control (local dimming control) for each of a plurality of partial regions, and realizes a thin-shaped and light-weight backlight device which can easily secure uniform luminance.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A surface lighting apparatus comprising:
a plurality of surface light source units stacked one on another, each of the surface light source units comprising a light guide plate and a plurality of light-emitting units, the light guide plate comprising a light incident surface for introducing light emitted by the light-emitting units, a front surface, a back surface opposed to the front surface, and a light-outputting region configured to output light introduced from the light incident surface through the front surface, the front surface being provided with a light transmission control part to prevent light from diffusing in a direction of arranging the light-emitting units, the light-emitting units being linearly arranged opposite to the light incident surface and configured to emit light toward the light incident surface; and
a control unit configured to control a light intensity for each of the light-emitting units,
wherein a light guide plate of each surface light source unit other than a lowermost surface light source unit of the surface light source units further comprises a window region configured to transmit light which is output from one or more lower surface light source units and is introduced from a back surface thereof.

2. The apparatus according to claim 1, wherein
in each surface light source unit other than the lowermost light source unit, the window region is provided on a side of the light incident surface, the light-outputting region is provided on a side of a side surface opposed to the light incident surface,
a window region of a light guide plate of a certain surface light source unit of the surface light source units is shorter, in a direction perpendicular to the light incident surface of the certain surface light source unit, than a window region of a light guide plate of a surface light source unit which is located upper than the certain surface light source unit, and
the light guide plate of the certain surface light source unit of the surface light source units is shorter, in a direction perpendicular to the light incident surface, than the light guide plate of the surface light source unit which is located upper than the certain surface light source unit.

3. The apparatus according to claim 1, wherein
the light transmission control part comprises a depressed part and a projecting part which are linearly extended in a direction perpendicular to the light incident surface.

4. The apparatus according to claim 1, further comprising a light shielding member configured to prevent light emitted by light-emitting units of a certain surface light source unit of the surface light source units from being made incident on light guide plates of the surface light sources other than the certain surface light source unit.

5. The apparatus according to claim 1, wherein
the light guide plate included in each of the surface light source units further comprises a side surface different from the light incident surface, the front surface, and the back surface, and
at least a part of the side surface and at least a part of the back surface are subjected to light absorption processing to adsorb light.

6. A surface lighting apparatus comprising:
a plurality of surface light source units stacked one on another, each of the surface light source units comprising a light guide plate, first light-emitting units, and second light-emitting units, the light guide plate comprising a first light incident surface for introducing light emitted by the first light-emitting units, a second light incident surface for introducing light emitted by the second light-emitting units, a front surface, a back surface opposed to the front surface, a first light-outputting region configured to output light introduced from the first light incident surface through the front surface, and a second light-outputting region configured to output light introduced from the second light incident surface through the front surface, the front surface being provided with a light transmission control part to prevent light from diffusing in a direction of arranging the first light-emitting units, the first light-emitting units being linearly arranged opposite to the first light incident surface and configured to emit light toward the first light incident surface, the second light-emitting units being linearly arranged parallel to the first light-emitting units and opposite to the second light incident surface and configured to emit light toward the second light incident surface; and
a control unit configured to control a light intensity for each of the light-emitting units,
wherein a light guide plate of each surface light source unit other than a lowermost surface light source unit of the surface light source units further comprises a window region configured to transmit light which is output from one or more lower surface light source units and is introduced from a back surface thereof.

7. The surface lighting apparatus of claim 6, wherein
a first light-outputting region and a second light-outputting region of a light guide plate of a uppermost surface light source unit of the surface light source units are provided in a center part which is distant from the first light incident surface and the second light incident surface, and
a light guide plate of each surface light source unit other than the uppermost surface light source unit is separated into two sections in a center part which is distant from the first light incident surface and the second light incident surface.
